(19) United States
(12) Patent Application Publication
(10) Pub. No.: US 2008/0142612 A1
(43) Pub. Date: Jun. 19, 2008

(54) Adjustable Effect Water Fountain

(76) Inventor: Stephen Dale Potter, San Francisco, CA (US)

Correspondence Address: QUICKPATENTS, INC., 32861 CALLE PERFECTO, SUITE A, SAN JUAN CAPISTRANO, CA, 92675, US

(21) Appl. No.: 11/611,062

(22) Filed: Dec. 14, 2006

(51) Int. Cl. B05B 17/08; B05B 17/00

(52) U.S. Cl. 239/17; 239/211

(57) ABSTRACT

An adjustable variable-effect fountain for a liquid, such as water, is disclosed. A support frame includes an upper support level, under which a pump is adapted to fit. The support frame includes a base that has a substantially hollow, water impermeable enclosure with an open top end. A cover plate having at least one apertures therein is adapted to fit at least partially within the top open end of the base to form the upper support level. An elongated pipe has an upper open end and a lower end adapted to engage an outlet port of the pump, and at least one of the apertures in the cover plate is of sufficient size to receive the pipe therethrough. A plurality of stackable members each include at least one aperture therethrough, each aperture being of sufficient size to receive the pipe therethrough. A bottom-most member is supported by the upper support level of the support frame. The plurality of stackable members are each stacked one-on-another on the support frame with the elongated pipe traversing one of the at least one apertures of each stackable member. As such, a user may stack the stackable members in any order and in any rotational orientation to produce any one of numerous waterfall effects.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE INVENTION

This invention relates to water fountains, and more particularly to a novel adjustable water fountain.

### DISCUSSION OF RELATED ART

Water fountains are a well-known means of providing relaxation and enjoyment to people in a variety of environments. The sounds of trickling water and the effects water fountains can create are nearly hypnotizing in their effect, and accordingly there are many prior art waterfall devices that attempt to improve on waterfall devices, from garden-type waterfalls for outdoor use to miniature desktop fountains. A key component of most prior art waterfall devices is the means by which such devices create a trickling sound by specific placement of obstructions in the flow of water, typically driven by an electric pump.

For example, U.S. Pat. No. 356,054 to Vorck on Jan. 11, 1887, teaches an artificial cascade. Such a device produces a strong tricking noise due to the many obstructions in its water path. Further, such a device is pleasant to look at and creates a relaxing environment wherever used. Other examples of such waterfall or fountain devices are found in U.S. Pat. D378,773 to Wood on Apr. 8, 1997; U.S. D378,120 to Wood on Feb. 18, 1997; U.S. D213,692 to Hibben on Apr. 1, 1969; and U.S. Pat. No. 6,290,144 to Maxwell on Sep. 18, 2001. Such devices, while pleasant and relaxing to watch, can quickly become so familiar in one's environment that they become unnoticed. As such, it would be beneficial to be able to vary the look or sound of such a device as desired.

Some prior art devices are adjustable to a small degree. For example, U.S. Pat. No. 6,209,797 to Jenney on Apr. 3, 2001 teaches a waterfall fountain that can be adjusted to produce differing effects, although the adjustments are limited to angular positions of the “leaves” of each tier. As such, the overall affect of rotating one of the tiers slightly is minor and has very little impact on the overall effect created by such a device. U.S. Pat. D437,628 to Sater et al. on Feb. 13, 2001, and U.S. Pat. No. 6,883,722 to Pankow on Apr. 26, 2005, both teach waterfall fountain devices that include a plurality of stones set within the water path. Presumably such stones could be rotated, stacked, or otherwise adjusted, but the overall effect created by such devices remains substantially the same even after such adjustments. Dramatic change to the water path is not accomplished with such devices, and as such they have the same drawbacks as those prior art devices mentioned previously.

One prior art device, taught in U.S. Pat. No. 1,322,803 to MacFadden on Nov. 25, 1919, teaches a stacked tier waterfall device. Such a device does not allow for its tiers to be adjusted vertically; however, if the tiers of such a device could be stacked in any order the overall effect of such a device would change considerably. For example, if the lower, largest diameter tier were raised upwards close to the top of the device, a much taller drop would be introduced to the device. Of course, smaller tiers below the larger tier would have no effect. As it stands, such a modified device would be of little additional value in terms of overcoming the drawbacks previously mentioned.

There is a need, therefore, for a waterfall device that allows for the creation of a widely adjustable water flow effects. Such a needed device would be easy to use and adjust, and would allow for unlimited variations of water flow paths. Further, such a needed device could be adapted to use in outdoor environments, such as in existing ponds or water features, or could be adapted for use in smaller indoor environments such as freestanding floor embodiments or desktop embodiments. Such a needed device would be easy to clean, and relatively inexpensive. The present invention accomplishes these objectives.

### SUMMARY OF THE INVENTION

The present device is a fountain for a liquid, such as water. A support frame includes an upper support level, under which a pump is adapted to fit. An elongated pipe has an upper open end and a lower end adapted to engage an outlet port of the pump. The support frame includes a base that has a substantially hollow, water impermeable enclosure with an open top end. A cover plate having at least one apertures therein is adapted to fit at least partially within the top open end of the base to form the upper support level. At least one of the apertures in the cover plate is of sufficient size to receive the pipe therethrough.

A plurality of stackable members each include at least one aperture therethrough, each aperture being of sufficient size to receive the pipe therethrough. A bottom-most member is supported by the upper support level of the support frame. Each member in the plurality of members may be substantially identical in shape but not in size, uniquely shaped and sized, or substantially identical in size but not shape. Each member may be made out of stone, resin, plastic, transparent, translucent, glass, metallic, ceramic, wood, sea shell, or any other suitable material that is not damaged by prolonged exposure to the liquid. The stackable members may be differently colored or textured from other stackable members.

Each stackable member is preferably substantially flat on its top and bottom surfaces, but may include a depression or a raised portion. Each stackable member includes a peripheral edge that may be substantially vertical, slanted, rounded, pointed, or otherwise shaped so as to affect the flow of the liquid over the stackable member.

In use, the plurality of stackable members are each stacked one-on-another on the support frame with the elongated pipe traversing one of the at least one apertures of each stackable member. The pump is submerged in the liquid and power is applied thereto to cause the pump to pump the liquid up the pipe. Once exiting the upper open end, the liquid spills down each stackable member in turn until it returns to the pump. A user may stack the stackable members in any order and in any rotational orientation to produce a desired waterfall effect.

The present invention is a waterfall device that allows for the creation of a widely adjustable water flow effects. The present invention is easy to use and adjust, and allows for unlimited variations of water flow paths. As new materials become available for the stackable members, they can easily be incorporated into previously manufactured such devices. Further, the present device may easily be adapted for use in outdoor environments, such as in existing ponds or water features, and can be adapted for use in smaller indoor environments such as freestanding floor embodiments and desktop embodiments. The present invention is further easy to clean and relatively inexpensive to manufacture. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a perspective view the present invention, illustrating a fountain having a plurality of stackable members stacked on an elongated pipe;

FIG. 2 is a cross-sectional partially exploded perspective view of the invention, taken generally along lines 2-2 of FIG. 1, and further illustrating the pipe engaged with a liquid pump of the invention;

FIG. 3 is a partially exploded perspective view of the invention, illustrating a base having a cover plate for enclosing the liquid pump;

FIG. 4 is a cross-sectional partially exploded view of the invention, taken generally along lines 2-2 of FIG. 1, and illustrating an embodiment having alternate stackable members;

FIG. 5 is a rear elevational view of the invention, illustrating a power cord traversing a power cord aperture in one side of the base, and further including a water tight seal;

FIG. 6 is a top plan view of the invention, illustrating an embodiment wherein the stackable members include a central aperture and an offset aperture for stacking on the pipe;

FIG. 7 is a top plan view of an alternate shape for one of the stacking members;

FIG. 8 is a top plan view of an alternate shape for one of the stacking members;

FIG. 9 is a top plan view of an alternate shape for one of the stacking members;

FIG. 10 is a top plan view of an alternate shape for one of the stacking members;

FIG. 11 is a top plan view of an alternate shape for one of the stacking members;

FIG. 12 is a top plan view of an alternate shape for one of the stacking members;

FIG. 13 is a top plan view of an alternate shape for one of the stacking members;

FIG. 14 is a partial cross-sectional view of a stack of the stackable members, illustrating an embodiment wherein each stackable member has a vertical side edge;

FIG. 15 is a partial cross-sectional view of a stack of the stackable members, illustrating an embodiment wherein each stackable member has a upward-slanted side edge;

FIG. 16 is a partial cross-sectional view of a stack of the stackable members, illustrating an embodiment wherein each stackable member has a downward-slanted side edge;

FIG. 17 is a partial cross-sectional view of a stack of the stackable members, illustrating an embodiment wherein each stackable member has a rounded side edge;

FIG. 18 is a partial cross-sectional view of a stack of the stackable members, illustrating an embodiment wherein each stackable member has a pointed side edge;

FIG. 19 is a cross-sectional view of a stackable member having a raised portion; and

FIG. 20 is a cross-sectional view of a stackable member having a depression.

### DETAILED DESCRIPTION OF THE PREFERRED EMBODIMENT

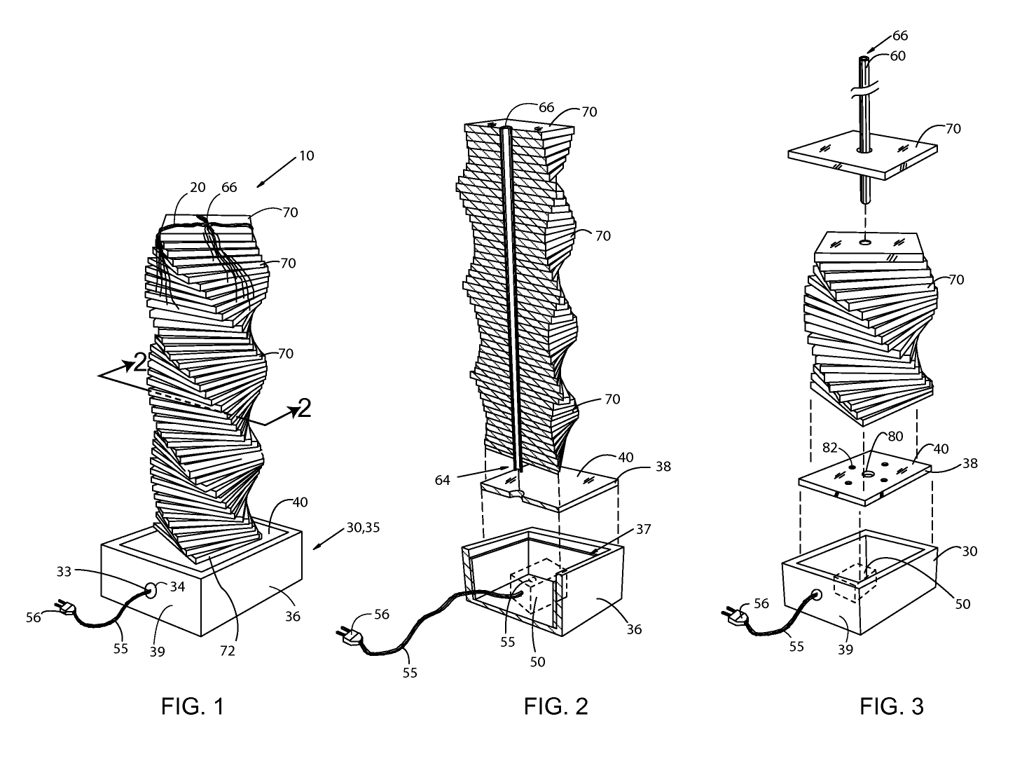

FIGS. 1 through 6 illustrate a fountain 10 for a liquid 20, such as water, a beverage, or the like. A support frame 30 includes an upper support level 40, under which a pump 50 is adapted to fit. An elongated pipe 60 has an upper open end 66 and a lower end 64 adapted to engage an outlet port 55 of the pump 50 (FIG. 2). In its simplest embodiment, the support frame 30 is an open frame (not shown) that is submerged in a pond or other liquid body. The pump 50 fits beneath the upper support level 40 of the support frame 30 and rests on the floor of the pond or other suitable support (not shown).

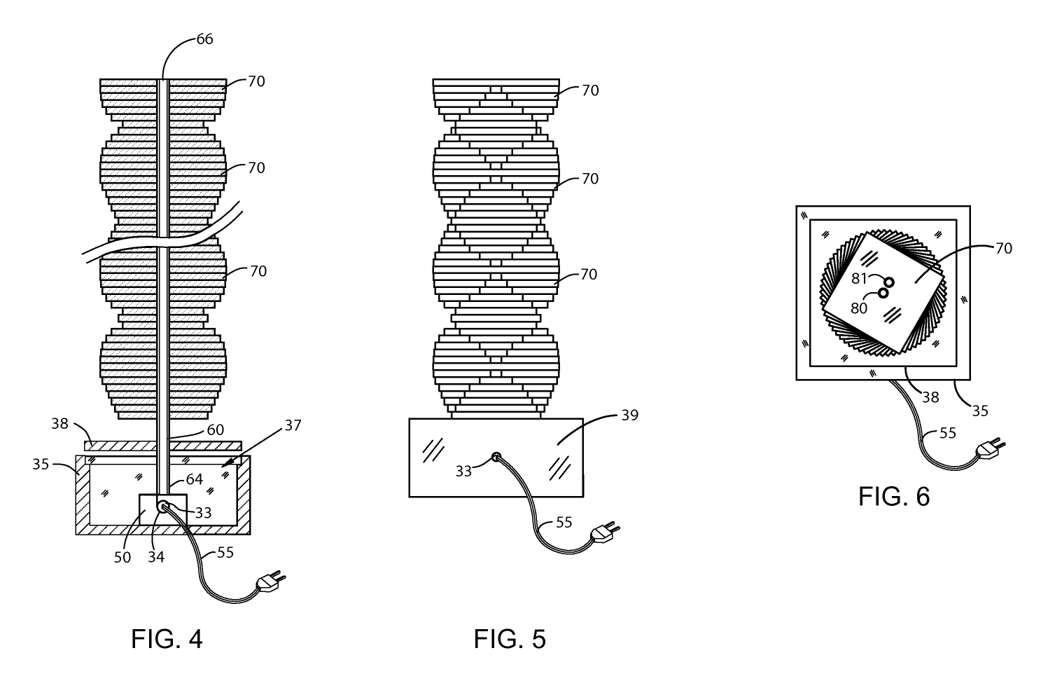

Preferably, however, the support frame further includes a base 35 that has a substantially hollow, water impermeable enclosure 36 with an open top end 37. A cover plate 38 having at least one apertures 80 therein is adapted to fit at least partially within the top open end 37 of the base 35 to form the upper support level 40 (FIGS. 2 and 4). At least one of the apertures 80 in the cover plate 38 is of sufficient size to receive the pipe 60 therethrough. Other apertures 82, or other drainage means such as slots or gaps between the cover plate 38 and the enclosure 36 (not shown), may be included for allowing the liquid 20 to drain back into the enclosure 36 from the top of the cover plate 38 (FIG. 2).

The pump 50 is preferably an electric pump 50 that includes a power cord 55 traversing a power cord aperture 33 in one side 39 of the base 35. The power cord 55 and the power cord aperture 33 together form a water tight seal 34 in the base 35. Silicon rubber, or other sealing means, such as grommets or the like (not shown), may be introduced between the power cord 55 and the aperture 33 to form the water tight seal 34 (FIGS. 1 and 4). Alternately, the power cord 55 may traverse a bottom side of the base 35 (not shown), between the cover plate 38 and the enclosure 36 (not shown), or through the cover plate 38 (not shown), as desired.

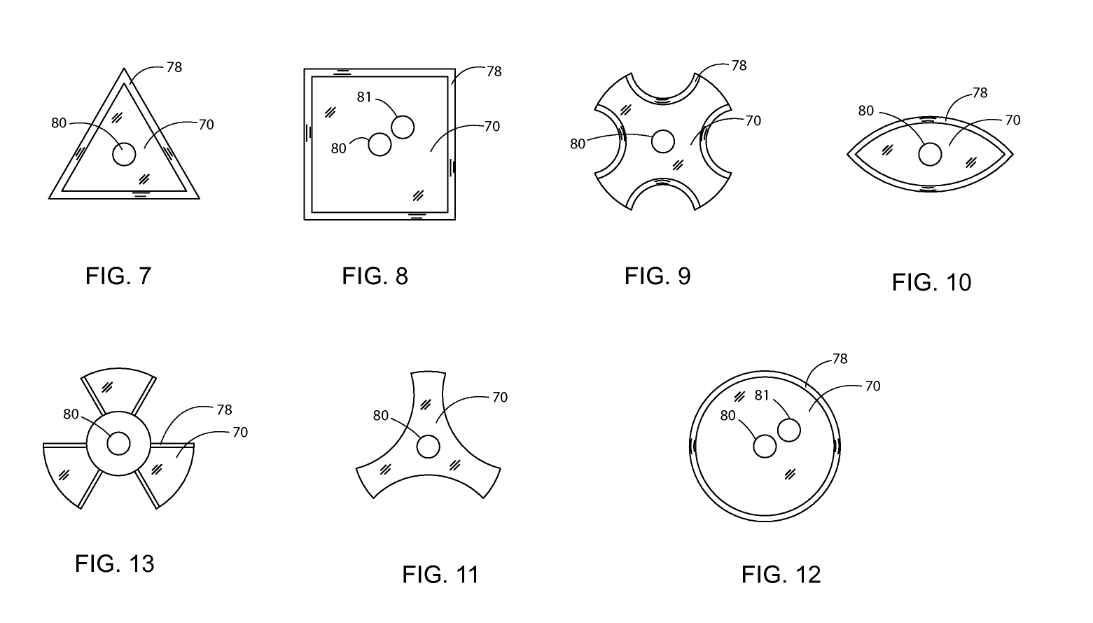

A plurality of stackable members 70 each include at least one aperture 80 therethrough, each aperture 80 being of sufficient size to receive the pipe 60 therethrough. A bottom-most member 72 is supported by the upper support level 40 of the support frame 30 (FIG. 1). Each member 70 in the plurality of members 70 may be substantially identical in shape but not in size, uniquely shaped and sized, or substantially identical in size but not shape (FIGS. 7 through 13). Each member 70 may be made out of stone, resin, plastic, transparent, translucent, glass, metallic, ceramic, wood, sea shell, or any other suitable material that is not damaged by prolonged exposure to the liquid 20. The stackable members may be differently colored or textured from other stackable members.

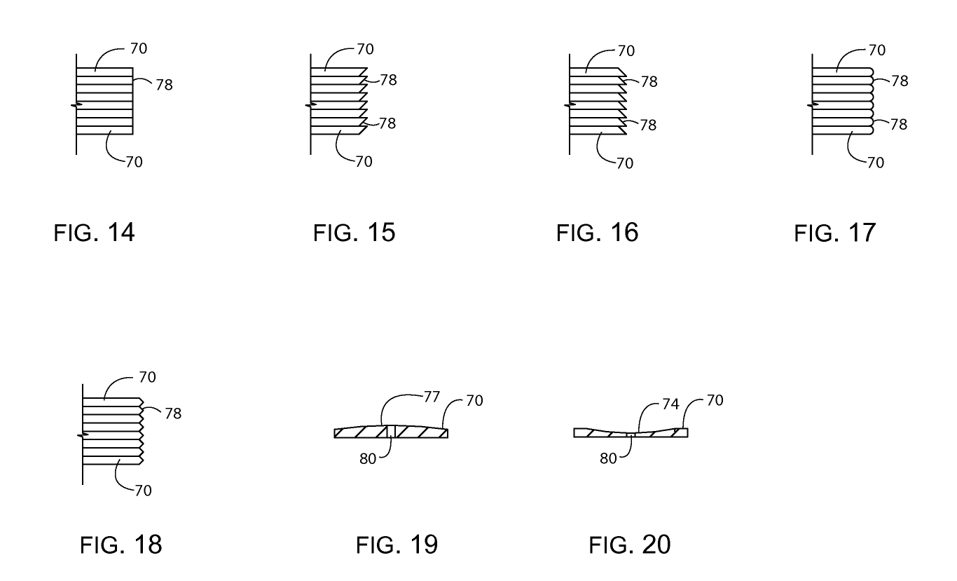

Each stackable member 70 is preferably substantially flat on its top and bottom surfaces, but may include a depression 74 or a raised portion 77 (FIGS. 19, 20), particularly with the top-most stackable member 70. Each stackable member 70 includes a peripheral edge 78 that may be substantially vertical, slanted, rounded, pointed, or otherwise shaped so as to affect the flow of the liquid 20 over the stackable member 70 (FIGS. 14 through 18).

Each aperture 80 can be formed in any desired cross-sectional shape so as to match any particular cross-sectional shape of pipe 60, thereby constraining the rotational orientation of each stackable member 70, if desired. For example, a five-pointed star shaped pipe 60 (not shown) constrains stackable members 70 having corresponding star-shaped apertures 80 to five rotational orientations with respect to the pipe 60. Preferably, however, each aperture 80 is circular in shape, as is the cross-sectional shape of the pipe 60, so that any rotational orientation of the stackable members 70 is achievable. Each stackable member 70 preferably includes at least one aperture 80 in a central portion thereof, but may further include additional offset apertures 81 away from the central portion thereof (FIGS. 6, 8, and 12). Preferably the top-most stackable member 70 includes only the one aperture 80 so that the liquid 20 does not drain through quickly through other apertures 81, but instead spills over its peripheral edges 78.

In use, the plurality of stackable members 70 are each stacked one-on-another on the support frame 40 with the elongated pipe 60 traversing one of the at least one apertures 80 of each stackable member 70. The pump 50 is submerged in the liquid 20 and power is applied thereto to cause the pump 50 to pump the liquid 20 up the pipe 60. Once exiting the upper open end 66, the liquid 20 spills down each stackable member 70 in turn until it returns to the pump 50. As such, the stackable members 70 may be stacked in any order and in any rotational orientation, flipped top-side-up or top-side-down, to produce any number of waterfall effects.

While a particular form of the invention has been illustrated and described, it will be apparent that various modifications can be made without departing from the spirit and scope of the invention. For example, the exact number, shape, material, and size of each stackable member 70 may be varied greatly from those illustrated in the drawings. Further, a variety of support frames 30 may be used, combined with diverse objects such as planters, statues, or the like. Accordingly, it is not intended that the invention be limited, except as by the appended claims.

What is claimed is:

1. A fountain for a liquid pumped through a pump having an outlet port and an inlet port, comprising:
a support frame including an upper support level;
an elongated pipe having a lower end in fluid communication with the outlet port of the pump and an upper open end, the pipe supported by the support frame, adapted for traversing the upper support level of the support frame, and adapted for conveying the liquid therethrough;
a plurality of stackable members each having at least one aperture therethrough of sufficient size to receive the pipe therethrough, a bottom-most member being supported by the upper support level of the support frame;
whereby with the plurality of stackable members each stacked one-on-another on the support frame, the elongated pipe traversing the aperture of each member, the pump pumps the liquid through the pipe to spill down the stackable members, the support frame directing the liquid back to the inlet port of the pump.

2. A fountain for a liquid, comprising:
a support frame including an upper support level;
a pump adapted to fit below the upper support level of the support frame;
an elongated pipe having a lower end adapted to engage an outlet port of the pump and an upper open end, the pipe adapted for traversing the upper support level of the support frame and for conveying the liquid therethrough;
a plurality of stackable members each having at least one aperture therethrough of sufficient size to receive the pipe therethrough, a bottom-most member being supported by the upper support level of the support frame;
whereby with the plurality of stackable members each stacked one-on-another on the support frame, the elongated pipe traversing the aperture of each member, the pump pumps the liquid through the pipe to spill down each of the stackable members and return back to the pump.

3. The fountain of claim 2 wherein the support frame comprises a base that has a substantially hollow, water impermeable enclosure having an open top end, and a cover plate having at least one aperture therein, the cover plate adapted to fit at least partially within the top end of the base to form the upper support level.

4. The fountain of claim 3 wherein the pump includes a power cord traversing a power cord aperture in one side of the base, the power cord and power cord aperture together forming a water tight seal in the base.

5. The fountain of claim 1 wherein each stackable member is substantially identical in shape and size.

6. The fountain of claim 1 wherein each stackable member is substantially identical in shape but not necessarily in size.

7. The fountain of claim 1 wherein each stackable member is a unique shape and size.

8. The fountain of claim 1 wherein at least one of the plurality of stackable member is made of a stone material.

9. The fountain of claim 1 wherein at least one of the plurality of stackable member is made of a resin material.

10. The fountain of claim 1 wherein at least one of the plurality of stackable member is made of a transparent material.

11. The fountain of claim 1 wherein at least one of the plurality of stackable member is made of a colored translucent material.

12. The fountain of claim 1 wherein at least one of the plurality of stackable member is made of a glass material.

13. The fountain of claim 1 wherein at least one of the plurality of stackable member is made of a metallic material.

14. The fountain of claim 1 wherein at least one of the plurality of stackable member is made of a ceramic material.

15. The fountain of claim 1 wherein at least one of the plurality of stackable member is made of wood.

16. The fountain of claim 1 wherein at least one of the plurality of stackable member is made of a sea shell.

17. The fountain of claim 1 wherein at least one of the plurality of stackable member is made of a plastic material.

18. The fountain of claim 1 wherein at least one of the plurality of stackable member is made of a composite material.

19. The fountain of claim 1 wherein the pipe is essentially cylindrical and each aperture in each stackable member is substantially circular, such that each stackable member may rotate freely with respect to the pipe.

20. The fountain of claim 1 wherein the pipe is non-cylindrical and each aperture in each stackable member is of a corresponding shape, such that each stackable member is restrained to at least one rotational orientation on the pipe.

21. The fountain of claim 1 wherein at least one of the stackable members includes at least one depression therein for pooling the liquid.

22. The fountain of claim 1 wherein at least one of the stackable members includes at least one raised area.

23. The fountain of claim 1 wherein at least one of the stackable members includes at least two apertures therethrough, each of sufficient size to receive the pipe therethrough, such that the at least one stackable member may be stacked in at least two horizontal positions with respect to the pipe.

24. The fountain of claim 1 wherein at least one of the stackable members includes a slanted edge, whereby the at least one stackable member may be placed on the pipe with its larger surface facing either down, to reduce waterfall noise, or up, to increase waterfall noise, at the edge thereof.

25. The fountain of claim 3 wherein the pump includes a power cord traversing a power cord aperture in a bottom side of the base, the power cord and power cord aperture together forming the water tight seal in the base.
